(19) United States
(12) Patent Application Publication
(10) Pub. No.: US 2007/0126718 A1
(43) Pub. Date: Jun. 7, 2007

(54) Method and system of many-to-one transmission and information display via local area network

(75) Inventors: Chan-lung Wu, Hsinchu (TW); Tse-hung Chu, Hsinchu (TW); Vincent Yen, Hsinchu (TW); Hsiao-Ian Tsai, Taipei (TW); Chun-ming Lai, Hsinchu (TW)

Correspondence Address: PAI PATENT & TRADEMARK LAW FIRM, 1001 FOURTH AVENUE, SUITE 3200, SEATTLE, WA, 98154, US

(73) Assignee: NEWSOFT TECHNOLOGY CORPORATION

(21) Appl. No.: 11/418,759

(22) Filed: May 5, 2006

(30) Foreign Application Priority Data
Dec. 1, 2005 (TW) 94142368

(51) Int. Cl. G09G 5/00

(52) U.S. Cl. 345/204

(57) ABSTRACT

A many-to-one transmission and information display method via local area network is implemented in a local area network comprising a first electronic device, at least one second electronic device, and at least one processing device connected to an output device to display information. In this method, a predetermined display information to be transmitted to the processing device is adjusted in advance based on a frame layout by the first electronic device and the second electronic device, respectively; then the adjusted predetermined display information is transmitted to the processing device to be integrated into the display information for the output device to display, thereby reducing the amount of data for transmission and the computation of integration process. A many-to-one transmission and information display system via local area network is also disclosed.

### BACKGROUND OF THE INVENTION

a) Field of the Invention

The invention relates to a method and a system of many-to-one transmission and information display via local area network and, more particularly, to a method and a system of many-to-one transmission and information display which save network bandwidth and reduce the workload of information-display process.

b) Description of the Related Art

Due to the fast development of information technology, digitized applications of information are becoming more ordinary. One application is to divide a screen frame into multiple display areas and respectively assign the display areas to multiple information sources, such that different information can be displayed in one screen frame at the same time, for example, when a meeting is in progress.

Referring to FIG. 1, to realize the abovementioned object of many-to-one transmission and information display, a conventional many-to-one transmission and information display system 1 is used to transmit unprocessed data (UPD) of second electronic devices 12, 13 to a first electronic device 11. Together with its own UPD and the UPD from the second electronic devices 12, 13, the first electronic device 11 performs integration process of frames and then transmits the integrated processed frames (IPF) to a third electronic device 14. Last, the third electronic device 14 sends the IPF to an output device 15 for output.

Referring to FIG. 2, another conventional many-to-one transmission and information display system 2 is shown. A first electronic device 21 first transmits information of a frame layout (LO) to a third electronic device 24. Then, the first electronic device 21 and second electronic devices 22, 23 respectively transmit their UPD to the third electronic device 24. The third electronic device 24 performs integration process of frames based on the frame layout already received. Last, the third electronic device 24 sends the IPF to the output device 15 for output.

The two abovementioned conventional methods have the defects listed below. First, since the first electronic device, the second electronic device, and the third electronic device are connected via local area network, if information is to be directly transmitted without being processed first, the network bandwidth would be greatly consumed, which in turn would affect other users of the network and even cause the frame delay problem. Second, whether it is the first electronic device 11 or the third electronic device 24 that performs the integration process of frames, the information integrating end (the first electronic device 11 or the third electronic device 24) must have a good computational ability. Hardware with better computational ability means a higher hardware cost. In addition, when the computational ability is insufficient, the frame delay problem would occur.

Concluding from above, to improve on the network bandwidth consumption for many-to-one transmission and information display systems, and to reduce the computation required of the information integrating end to process frame integration are the goals to be achieved.

### SUMMARY OF THE INVENTION

In view of the aforementioned problems, an object of the invention is to provide a method and a system of many-to-one transmission and information display via local area network, which can reduce the consumption of network bandwidth and the computation required of the information integrating end to process frame integration.

To achieve the aforementioned object, a many-to-one transmission and information display method via local area network of the invention is implemented in a local area network comprising a first electronic device, at least one second electronic device, and at least one processing device connected to an output device to display information. The method includes: the first electronic device providing a list of processing devices in the local area network for a user to select one processing device; the first electronic device transmitting a frame layout to the selected processing device, the frame layout including M display areas and the geometric information of each display area, wherein M≧2 and M is an integer, and each display area is associated with a display content; the first electronic device transmitting an invitation request and the frame layout to the second electronic device; the second electronic device contacting the selected processing device when the second electronic device accepts the invitation request; the processing device sequentially assigning the M display areas based on an assignment rule to the first electronic device and N of the invited second electronic device(s) that has accepted the invitation request, to display information, wherein 1≦N≦M−1 and N is an integer; the first electronic device and the second electronic device respectively adjusting the geometric shape and size of a predetermined display information based on the geometric information of the assigned display areas, and respectively transmitting the adjusted predetermined display information to the processing device; the processing device receiving the adjusted predetermined display information and updating the display contents of the corresponding display areas; and the output device receiving the display information from the processing device and updating the display information regularly according to the display contents of the display areas.

A many-to-one transmission and information display system via local area network of the invention includes a first electronic device, at least one second electronic device, at least one processing device, and an output device. The output device is connected to the processing device via signals and is used to display information. The first electronic device, the second electronic device, and the processing device are provided in a local area network to execute the aforementioned method.

According to the method and system of many-to-one transmission and information display via local area network of the invention, the predetermined display information is adjusted before being transmitted, which effectively reduces the amount of data for transmission, and therefore effectively reduces the consumption of network bandwidth. As a result, the processing device just needs to directly integrate the predetermined display information into one display frame, and thus the computation required of the information integrating end to process frame integration is greatly reduced.

### BRIEF DESCRIPTION OF THE DRAWINGS

FIG. 1 is a conventional structure of many-to-one transmission and information display.

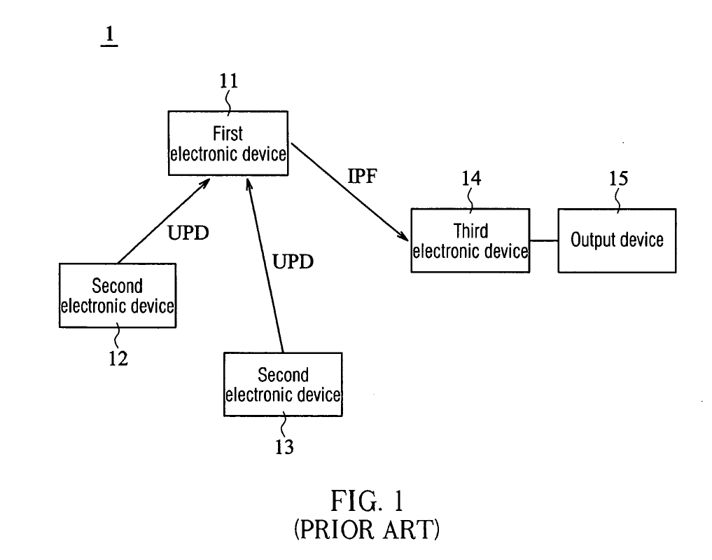

FIG. 2 is another conventional structure of many-to-one transmission and information display.

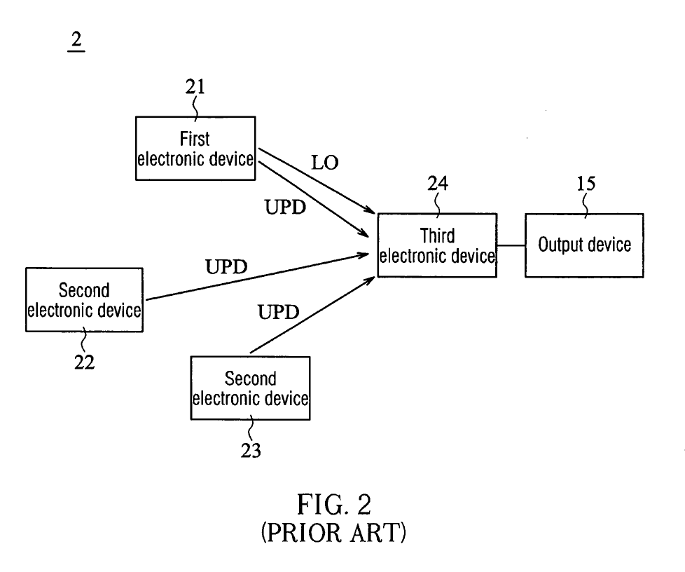

FIG. 3 is a method and system of many-to-one transmission and information display via local area network according to a preferred embodiment of the invention.

FIG. 4 is a flow chart illustrating the implementation steps of a first electronic device according to a preferred embodiment of the invention.

FIG. 5 is a flow chart illustrating the implementation steps of a second electronic device according to a preferred embodiment of the invention.

FIG. 6 is a flow chart illustrating the implementation steps of a processing device according to a preferred embodiment of the invention.

FIG. 7 is a flow chart illustrating the implementation steps of changing frame layouts in a preferred embodiment of the invention.

FIG. 8 is a schematic diagram illustrating a display frame according to a preferred embodiment of the invention.

FIG. 9 is a schematic diagram illustrating a user interface of a transmitting end in a preferred embodiment of the invention.

### DETAILED DESCRIPTION OF THE INVENTION

The preferred embodiments of a method and system of many-to-one transmission and information display via local area network according to the invention will be described in detail, with reference to the drawings in which like reference numerals denote like elements.

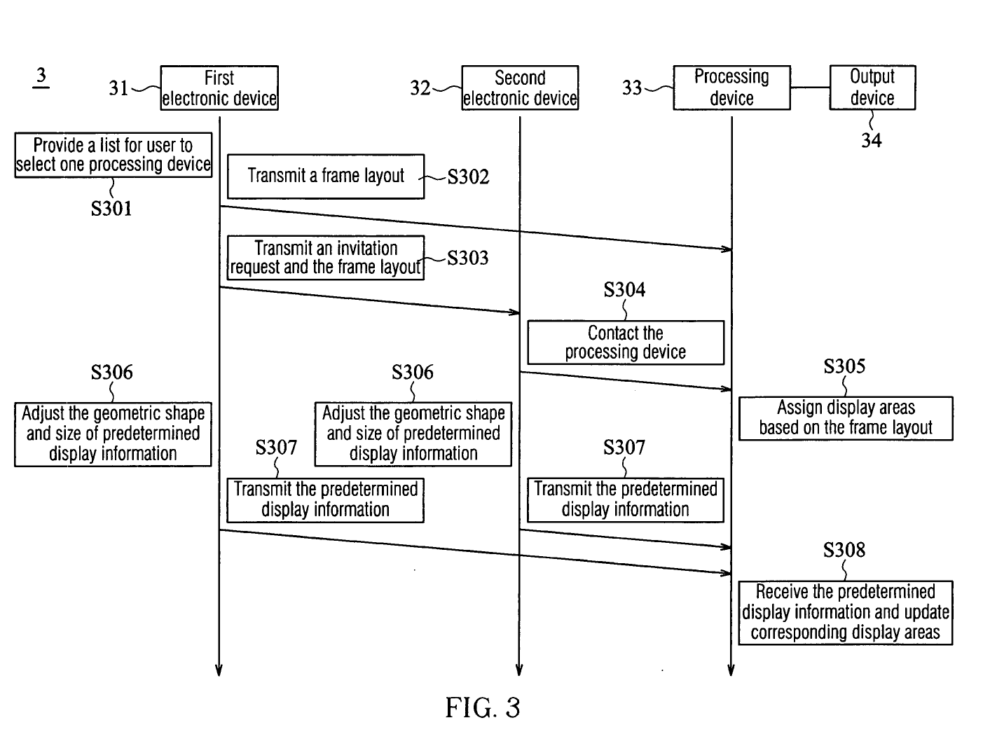

Referring to FIG. 3, a method of many-to-one transmission and information display via local area network according to a preferred embodiment of the invention is implemented in a local area network comprising a first electronic device 31, at least one second electronic device 32, and at least one processing device 33 connected to an output device 34 to display information. The information can be of many types, for example, information in the form of video, image, graphics, text, presentation, screen capture, or any combination thereof.

The execution of the method of the invention is shown in FIG. 3. First, the first electronic device 31 provides a list for a user to select one processing device 33 (S301), in which the list includes processing devices in the local area network. After the user selects the processing device 33, the first electronic device 31 establishes a connection to the selected processing device 33. The method of establishing network connection is well known to a person skilled in the art of the invention, for example, the first electronic device 31 contacts the selected processing device 33 with a use request and the selected processing device 33 returns a response to establish the connection, and therefore the method of establishing connection will not be further described herein. Second, the first electronic device 31 transmits a frame layout (LO) to the selected processing device (S302). The frame layout includes M display areas and the geometric information of each display area, wherein M≧2 and M is an integer, and each display area is associated with a display content. The first electronic device further transmits an invitation request and the frame layout to a second electronic device 32 (S303), inviting the second electronic device 32 to transmit information for the output device 34 to display. If the second electronic device 32 accepts the invitation, the second electronic device 32 would contact the selected processing device 33 (S304). Based on the frame layout and an assignment rule, the processing device 33 sequentially assigns the display areas to the first electronic device 31 and N of the invited second electronic device(s) that has accepted the invitation request 32, to display information (S305), wherein 1≦N≦M−1 and N is an integer. For example, dividing a screen frame into quadrants would create four display areas for four electronic devices to display information, wherein one display area is for the first electronic device 31 to use, and the remaining three display areas are assigned to the invited second electronic devices 32 that have accepted the invitation request, on the first-come first-served basis.

The first electronic device 31 and the second electronic device 32 adjust the geometric shape and size of predetermined display information, respectively, based on the geometric information of the display area assigned to each of them (S306), e.g. reducing the frame resolution, and then respectively transmit the adjusted predetermined display information to the processing device 33 (S307). The processing device 33 receives the adjusted predetermined display information and updates the display contents of the corresponding display areas according to the adjusted predetermined display information (S308). Last, the output device 34 receives the display information from the processing device 33 and updates the frame regularly according to the display content of each display area.

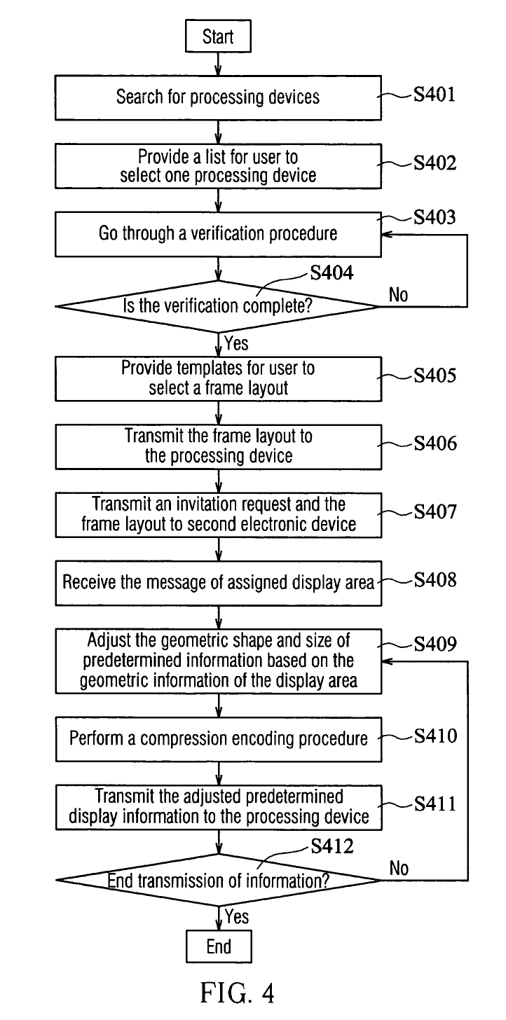

Referring to FIG. 4, the flow of execution of the first electronic device is described. First, the first electronic device 31 searches the local area network for processing devices (S401) and makes a list. This operation can be executed when the user requests for the list, or in advance when the first electronic device 31 or the local area network is idle. Next, the first electronic device 31 provides the list of processing devices for a user to select one processing device 33 (S402). After the user selects the processing device 33, the first electronic device 31 establishes a connection to the selected processing device 33; the connection method is well known to a person skilled in the art of the invention, and so will not be further described herein. The first electronic device 31 transmits a frame layout to the processing device 33 (S406) after the two devices are connected.

It is to be noted that if the processing device 33 has a security setting, the first electronic device 31 needs to go through a verification procedure (S403) when requesting to use the processing device 33, wherein the verification is done by methods such as entering passwords, etc. Only after the verification is complete (S404) can the subsequent steps in the flow be carried out, otherwise the verification procedure is repeated until the verification is complete or until the user relinquishes and exits the system. Moreover, the first electronic device 31 can provide a plurality of templates of the frame layout for the user to select (S405), such as frames divided into quadrants or a nine-paned frame, thus making it convenient for the user to plan the screen frame.

Next, the first electronic device 31 transmits an invitation request and the frame layout to the second electronic device 32 (S407). It is to be noted that the invitation request is not limited to any form. For example, it can be sent from the first electronic device 31, or it can even be sent by the user verbally, which is especially suitable during a meeting.

Based on the frame layout, the processing device 33 sequentially assigns the display areas to the first electronic device 31 and the invited second electronic device(s) 32 that has accepted the invitation request, for them to display information. After the first electronic device 31 receives the message of its assigned display area (S408), it adjusts the geometric shape and size of a predetermined display information based on the geometric information of the display area (S409). For example, if the display area is a rectangle, the geometric information of the display area would include the length and width of the rectangle, and/or the coordinates of two diagonal vertices of the rectangle. Then, the first electronic device 31 transmits the adjusted predetermined display information to the processing device 33 (S411). The last step is to determine whether the user has requested to end the transmission of information (S412), if no, return to step S409 and continue adjusting and transmitting predetermined display information. To further save network bandwidth, the first electronic device 31 can perform a compression encoding procedure (S410) before transmitting the predetermined display information, and the processing device 33 executes a corresponding decoding procedure upon receiving the compression encoded display information before the received information is processed normally.

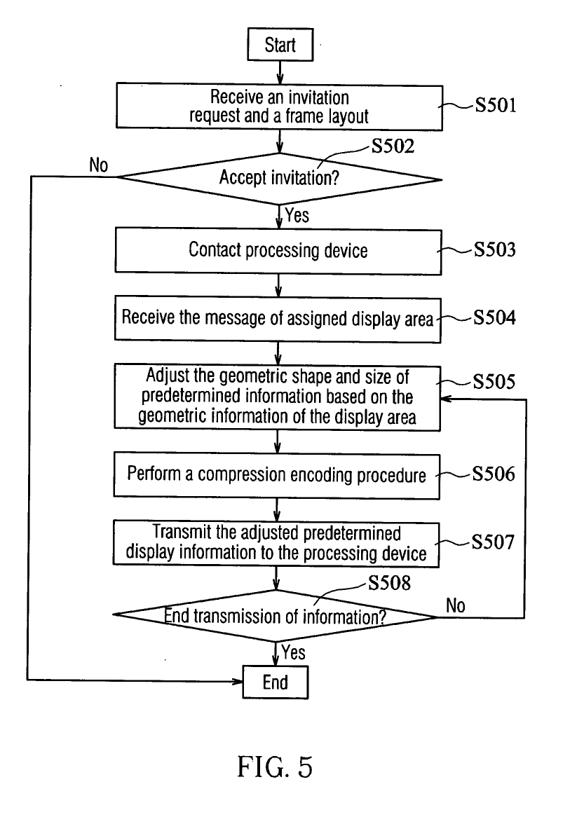

Referring to FIG. 5, the detailed flow of execution of the second electronic device is described. First, the second electronic device 32 receives an invitation request and a frame layout from the first electronic device 31 (S501). If the second electronic device 32 rejects the invitation (S502), the flow ends here; if the second electronic device 32 accepts the invitation (S502), the second electronic device 32 then contacts the processing device 33 to establish a connection (S503), e.g. by sending a use request. The processing device 33, based on the frame layout, sequentially assigns the display areas to the first electronic device 31 and the invited second electronic device(s) 32 that has accepted the invitation request, for them to display information. After the second electronic device 32 receives the message of its assigned display area (S504), it adjusts the geometric shape and size of a predetermined display information based on the geometric information of the display area (S505), and then transmits the adjusted predetermined display information to the processing device 33 (S507). The last step is to determine whether the user has requested to end the transmission of information (S508), if no, return to step S505 and continue to adjust predetermined display information and transmit the same. Like the first electronic device 31, the second electronic device 32 can perform a compression encoding procedure (S506) before transmitting the predetermined display information, and the processing device 33 executes a corresponding decoding procedure upon receiving the compression encoded information.

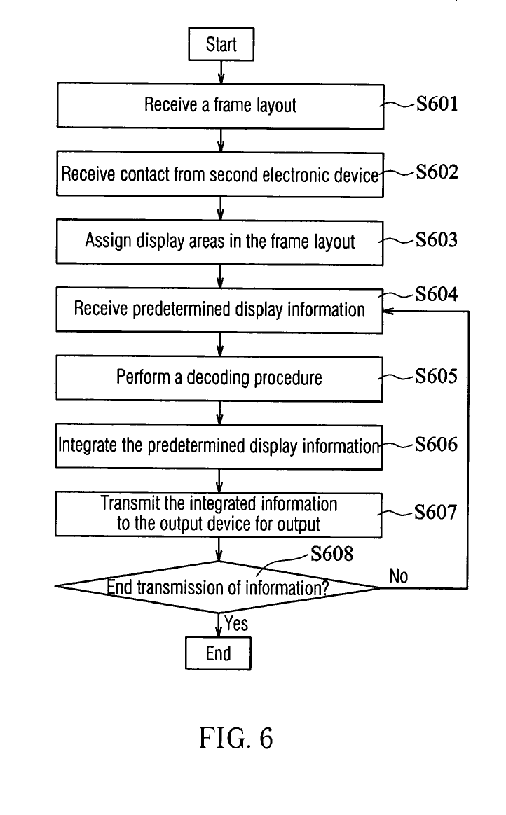

Referring to FIG. 6, the detailed flow of execution of the processing device 33 is described. First, after the processing device 33 and the first electronic device 31 are connected, the processing device 33 receives a frame layout transmitted by the first electronic device 31 (S601); the frame layout includes M display areas and the geometric information of each display area, wherein M≧2 and M is an integer, and each display area is associated with a display content. It is to be noted that if the processing device 33 has a security setting, the first electronic device 31 needs to go through a verification procedure first when establishing a connection to the processing device 33; the verification is done by methods such as entering passwords, etc. Next, the processing device 33 detects and receives a use request from the invited second electronic device 32 that has accepted the invitation request (S602). The processing device 33, according to the first-come first-served rule, assigns the display areas in the frame layout to the first electronic device 31 and the invited second electronic device 32 that has accepted the invitation request (S603). Afterwards, the processing device 33 receives the adjusted predetermined display information transmitted by the first electronic device 31 and the second electronic device 32 (S604). If the adjusted predetermined display information has been compression encoded, the processing device 33 performs a decoding procedure (S605) for the benefit of subsequent processes. The processing device 33 integrates the received adjusted predetermined display information into a display information (S606), which corresponds to the display frame, and transmits the display information to the output device 34 for output and display (S607). Steps S604 to S607 are repeated until the user has requested the flow to end.

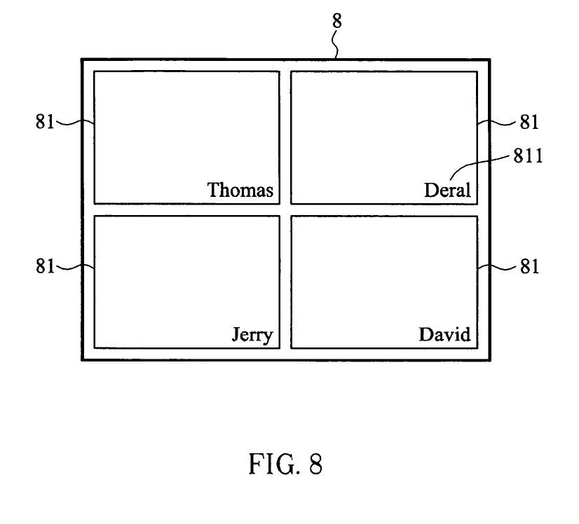

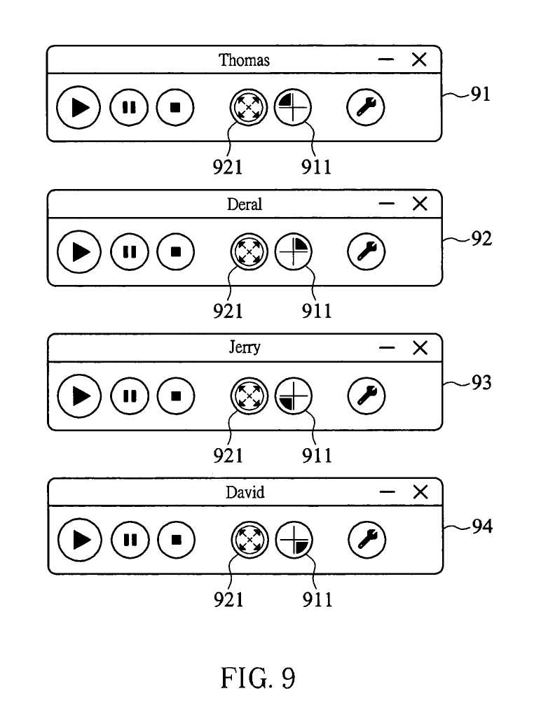

Referring to FIG. 8, besides assigning and integrating the predetermined display information in the display frame 8 based on the display areas 81 in the frame layout, the processing device 33 can also display the device names or user names of the first electronic device 31 and the second electronic device 32 within the corresponding display areas 81, respectively. As shown in FIG. 8, the user names 811 are labeled at the lower right corner of the corresponding display areas 81. Likewise, each of the user interfaces of the first electronic device 31 and the second electronic device 32 can also display which of the display areas each of them is using. As shown in FIG. 9, the images 911 on the user interfaces 91-94 at the transmitting ends illustrate the display areas currently in use. For example, in correspondence to the display areas of FIG. 8, the transmitting end Thomas is using the display area on the upper left corner, which is as shown by the image 911 on the user interface 91.

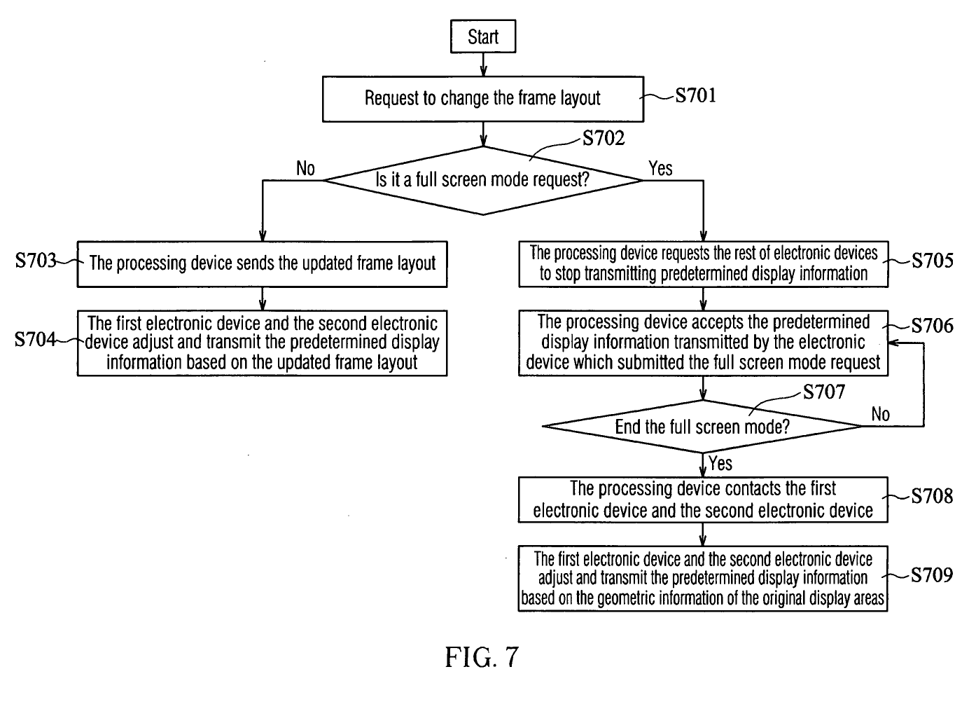

It is to be noted that the first electronic device 31 can change the frame layout as per user's request at anytime while repeating steps S409-S412. For example, the first electronic device 31 can request to change the assigned display areas with the same frame layout, or to directly change the frame layout, such as changing from a frame divided into quadrants to a nine-paned frame or a picture-in-picture frame. The same is for the second electronic device 32; it can also change the frame layout as per user's request at anytime while repeating steps S505-S508. The process flow of changing frame layout is as shown in FIG. 7. The first electronic device 31 or the second electronic device 32 requests the processing device 33 to change the frame layout (S701). The processing device 33 then determines whether it is a full screen mode request (S702); if no, go to step S703, where the processing device 33 notifies the first electronic device 31 and the second electronic device 32 of the updated frame layout. The first electronic device 31 and the second electronic device 32 then adjust the predetermined display information based on the updated frame layout and transmit the adjusted predetermined display information to the processing device 33 (S704), and the subsequent adjustment and transmission steps are as aforementioned and therefore will not be repeated herein.

If the request to change frame layout is a full screen mode, then go to step S705, in which the processing device 33 requests the first electronic device 31 or the second electronic device 32 that did not submit the full screen mode request to stop transmitting the predetermined display information, or the processing device 33 simply stops processing these predetermined display information. Next, the processing device 33 only accepts the predetermined display information transmitted by the first electronic device 31 or the second electronic device 32 which submitted the full screen mode request (S706). The next step is to determine whether the first electronic device 31 or the second electronic device 32 which submitted the full screen mode request has requested to terminate the full screen mode (S707); if no, repeat step S706, and if yes, the processing device 33 notifies the first electronic device 31 and the second electronic device 32 to resume transmitting the adjusted predetermined display information according to the display areas that were assigned to the first electronic device 31 and the second electronic device 32 before the full screen mode request was sent (S708). The first electronic device 31 and the second electronic device 32 adjust the predetermined display information based on the geometric information of the display areas that were assigned before the full screen mode request was sent (the original display areas) and transmit the adjusted predetermined display information (S709). It is to be noted that the processing device 33 can transmit a disable command when entering the full screen mode, so that full screen mode requests from the rest of the first electronic device 31 and the second electronic device 32 that did not submit the full screen mode request is ineffective. This is to prevent other electronic devices from submitting full screen mode requests during the full screen mode. For example, referring to FIG. 9, when the transmitting end Thomas presses its button 921 to activate full screen mode, the buttons 921 of the other transmitting ends become ineffective, and thus cannot execute full screen mode requests.

A system of many-to-one transmission and information display via local area network 3 according to a preferred embodiment of the invention is as shown in FIG. 3, which includes a first electronic device 31, at least one second electronic device 32, at least one processing device 33, and an output device 34. The first electronic device 31, the second electronic device 32, and the processing device 33 connect to one another via signals and form a local area network. The local area network can be a wired or a wireless local area network. The processing device 33 and the output device 34 are connected via signals by wired or wireless means, or can be directly integrated together as a whole. The output device 34 is used to display information; it can be a projector, a screen, or a television, etc.

The first electronic device 31, the second electronic device 32, and the processing device 33 execute the steps of the aforementioned method, and therefore will not be described herein. Take the system of the invention implemented in a wireless local area network as an example, each of the first electronic device 31, the second electronic device 32, and the processing device 33 can be a computer, a personal digital assistant, a mobile phone, a wireless projector adapter, a wireless setup box, a wireless digital media adapter, a wireless optical disc player, a wireless DVD player, a wireless video recorder, a wireless game console, a wireless portable media player, and so on.

According to the method and system of many-to-one transmission and information display of the invention, the predetermined display information is adjusted based on the geometric shape and size of the display areas before being transmitted, which effectively reduces the amount of data for transmission, and therefore the consumption of network bandwidth. Furthermore, since the predetermined display information has already been adjusted based on the geometric shape and size of the display areas by the first electronic device and the second electronic device before reaching the processing device, it only needs to be directly integrated into one display frame by the processing device, so the computation required of the information integrating end (the processing device of the invention) to process fame integration is thereby greatly reduced. Hence, hardware with relatively poor computational ability can be used to execute the invention and therefore the cost is lowered.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A many-to-one transmission and information display method via local area network, which is implemented in a local area network comprising a first electronic device, at least one second electronic device, and at least one processing device connected to an output device to display a display information, the method comprising:
the first electronic device providing a list of the at least one processing device in the local area network, for a user to select one processing device;
the first electronic device transmitting a frame layout to the selected processing device, the frame layout including M display areas and the geometric information of each display area, wherein M≧2 and M is an integer, and each display area is associated with a display content;
the first electronic device transmitting an invitation request and the frame layout to the at least one second electronic device;
the at least one second electronic device contacting the selected processing device upon accepting the invitation request;
the selected processing device sequentially assigning the M display areas according to an assignment rule to the first electronic device and N of the at least one second electronic device that has accepted the invitation request, wherein 1≦N≦M−1, and N is an integer;
the first electronic device and the N second electronic devices respectively adjusting the geometric shape and size of a predetermined display information according to the geometric information of the assigned display areas, and respectively transmitting the adjusted predetermined display information to the selected processing device;
the selected processing device receiving the adjusted predetermined display information and updating the display contents of the corresponding display areas according to the adjusted predetermined display information received; and
the output device receiving the display information from the selected processing device and updating the display information regularly according to the display contents of the display areas.

2. The many-to-one transmission and information display method via local area network as described in claim 1, wherein the list is made by the first electronic device searching the local area network for the at least one processing device.

3. The many-to-one transmission and information display method via local area network as described in claim 1, further comprising:
the first electronic device going through a verification procedure for the selected processing device before transmitting the frame layout to the selected processing device.

4. The many-to-one transmission and information display method via local area network as described in claim 1, further comprising:
the first electronic device providing a plurality of templates of the frame layout for the user to select from.

5. The many-to-one transmission and information display method via local area network as described in claim 1, further comprising:
at least one of the first electronic device and the N second electronic devices performing a compression encoding procedure before transmitting the adjusted predetermined display information to the selected processing device, and the selected processing device performing a corresponding decoding procedure upon receiving the adjusted predetermined display information.

6. The many-to-one transmission and information display method via local area network as described in claim 1, wherein the assignment rule is first-come first-served.

7. The many-to-one transmission and information display method via local area network as described in claim 1, further comprising:
the first electronic device or one of the N second electronic devices requesting the selected processing device to change the frame layout, wherein when the frame layout is changed, the selected processing device notifies the first electronic device and the N second electronic devices, and the first electronic device and the N second electronic devices adjust the geometric shape and size of the predetermined display information according to the geometric information of the changed display areas and transmit the adjusted predetermined display information to the selected processing device.

8. The many-to-one transmission and information display method via local area network as described in claim 1, further comprising:
when a full screen mode request is submitted to the selected processing device by the first electronic device or one of the N second electronic devices, the selected processing device requesting the rest of the first electronic device and the N second electronic devices to stop transmitting the predetermined display information, so that the output device displays in full screen the predetermined display information of the electronic device which submitted the full screen mode request, and the selected processing device further transmitting a disable command such that full screen mode requests from the rest of the first electronic device and the N second electronic devices are ineffective; and
when the full screen mode is terminated, the selected processing device notifying the first electronic device and the N second electronic devices to resume transmitting the adjusted predetermined display information according to the display areas that were assigned before the full screen mode request was submitted.

9. The many-to-one transmission and information display method via local area network as described in claim 1, further comprising:
the selected processing device respectively displaying the device names or user names of the first electronic device and the N second electronic devices in the corresponding display areas; and
the first electronic device and each of the N second electronic devices displaying which of the display areas each of them is using.

10. The many-to-one transmission and information display method via local area network as described in claim 1, wherein the geometric information of the display areas includes the length and width of a rectangle, or the coordinates of two diagonal vertices of a rectangle.

11. The many-to-one transmission and information display method via local area network as described in claim 1, wherein the local area network is a wireless local area network.

12. The many-to-one transmission and information display method via local area network as described in claim 11, wherein the first electronic device and each of the at least one second electronic device is a computer, a personal digital assistant, a mobile telephone, a wireless projector adapter, a wireless setup box, a wireless digital media adapter, a wireless optical disc player, a wireless DVD player, a wireless video recorder, a wireless game console, or a wireless portable media player.

13. The many-to-one transmission and information display method via local area network as described in claim 11, wherein each of the at least one processing device is a computer, a personal digital assistant, a mobile telephone, a wireless projector adapter, a wireless setup box, a wireless digital media adapter, a wireless optical disc player, a wireless DVD player, a wireless video recorder, a wireless game console, or a wireless portable media player.

14. The many-to-one transmission and information display method via local area network as described in claim 1, wherein the output device is a projector, a screen, or a television.

15. A many-to-one transmission and information display system via local area network, comprising:
a first electronic device;
at least one second electronic device, which is connected to the first electronic device via signals;
at least one processing device, which is connected to the first electronic device and the at least one second electronic device via signals; and
an output device for displaying a display information;
wherein the first electronic device, the at least one second electronic device, and the at least one processing device form a local area network;
the first electronic device provides a list of the at least one processing device in the local area network for a user to select one processing device;
the first electronic device transmits a frame layout to the selected processing device, the frame layout including M display areas and the geometric information of each display area, wherein M≧2, and M is an integer, and each display area is associated with a display content;
the first electronic device transmits an invitation request and the frame layout to the at least one second electronic device;
the at least one second electronic device contacts the selected processing device upon accepting the invitation request;
the selected processing device sequentially assigns the M display areas according to an assignment rule to the first electronic device and N of the at least one second electronic device that has accepted the invitation request, wherein 1≦N≦M−1, and N is an integer;
the first electronic device and the N second electronic devices respectively adjust the geometric shape and size of a predetermined display information according to the geometric information of the assigned display areas, and respectively transmit the adjusted predetermined display information to the selected processing device;
the selected processing device receives the adjusted predetermined display information and updates the display contents of the corresponding display areas according to the adjusted predetermined display information received; and
the output device receiving the display information from the selected processing device and updating the display information regularly according to the display contents of the display areas.

16. The many-to-one transmission and information display system via local area network as described in claim 15, wherein the list is made by the first electronic device searching the local area network for the at least one processing device.

17. The many-to-one transmission and information display system via local area network as described in claim 15, wherein the first electronic device goes through a verification procedure for the selected processing device before transmitting the frame layout to the selected processing device.

18. The many-to-one transmission and information display system via local area network as described in claim 15, wherein the first electronic device provides a plurality of templates of the frame layout for the user to select from.

19. The many-to-one transmission and information display system via local area network as described in claim 15, wherein at least one of the first electronic device and the N second electronic devices performs a compression encoding procedure before transmitting the adjusted predetermined display information to the selected processing device, and the selected processing device performs a corresponding decoding procedure upon receiving the adjusted predetermined display information.

20. The many-to-one transmission and information display system via local area network as described in claim 15, wherein the assignment rule is first-come first-served.

21. The many-to-one transmission and information display system via local area network as described in claim 15, wherein the first electronic device or one of the N second electronic devices can request the selected processing device to change the frame layout, and when the frame layout is changed, the selected processing device notifies the first electronic device and the N second electronic devices, and the first electronic device and the N second electronic devices adjust the geometric shape and size of the predetermined display information according to the geometric information of the changed display areas and transmit the adjusted predetermined display information to the selected processing device.

22. The many-to-one transmission and information display system via local area network as described in claim 15, wherein
when the selected processing device receives a full screen mode request from the first electronic device or one of the N second electronic devices, the selected processing device requests the rest of the first electronic device and the N second electronic devices to stop transmitting the predetermined display information, so that the output device displays in full screen the predetermined display information of the electronic device which submitted the full screen mode request, and the selected processing device further transmits a disable command such that full screen mode requests from the rest of the first electronic device and the N second electronic devices are ineffective; and
when the full screen mode is terminated, the selected processing device notifies the first electronic device and the N second electronic devices to resume transmitting the adjusted predetermined display information according to the display areas that were assigned before the processing device received the full screen mode request.

23. The many-to-one transmission and information display system via local area network as described in claim 15, wherein
the selected processing device respectively displays the device names or user names of the first electronic device and the N second electronic devices in the corresponding display areas; and
the first electronic device and each of the N second electronic devices displays which of the display areas each of them is using.

24. The many-to-one transmission and information display system via local area network as described in claim 15, wherein the geometric information of the display areas includes the length and width of a rectangle, or the coordinates of two diagonal vertices of a rectangle.

25. The many-to-one transmission and information display system via local area network as described in claim 15, wherein the local area network is a wireless local area network.

26. The many-to-one transmission and information display system via local area network as described in claim 25, wherein the first electronic device and each of the at least one second electronic device is a computer, a personal digital assistant, a mobile telephone, a wireless projector adapter, a wireless setup box, a wireless digital media adapter, a wireless optical disc player, a wireless DVD player, a wireless video recorder, a wireless game console, or a wireless portable media player.

27. The many-to-one transmission and information display system via local area network as described in claim 25, wherein the processing device is a computer, a personal digital assistant, a mobile telephone, a wireless projector adapter, a wireless setup box, a wireless digital media adapter, a wireless optical disc player, a wireless DVD player, a wireless video recorder, a wireless game console, or a wireless portable media player.

28. The many-to-one transmission and information display system via local area network as described in claim 15, wherein the output device is a projector, a screen, or a television.
